(19) United States
(12) Patent Application Publication
(10) Pub. No.: US 2023/0328805 A1
(43) Pub. Date: Oct. 12, 2023

(54) POLICY CONTROL FOR REDUNDANT TRANSMISSIONS

(71) Applicant: Telefonaktiebolaget LM Ericsson (publ), Stockholm (SE)

(72) Inventors: Maria Belen PANCORBO MARCOS, Madrid (ES); Fuencisla GARCIA AZORERO, Madrid (ES); Miguel Angel LOPEZ SERRANO, Madrid (ES); Susana FERNANDEZ ALONSO, Madrid (ES)

(73) Assignee: Telefonaktiebolaget LM Ericsson (publ), Stockholm (SE)

(21) Appl. No.: 18/020,517

(22) PCT Filed: Aug. 9, 2021
(86) PCT No.: PCT/EP2021/072176

§ 371 Date: Feb. 9, 2023

Related U.S. Application Data
(60) Provisional application No. 63/065,284, filed on Aug. 13, 2020.

(30) Foreign Application Priority Data
Aug. 13, 2020 (EP) 20382751.4

(51) Int. Cl. H04W 76/10

(52) U.S. Cl. CPC H04W 76/10; H04W 80/10

(57) ABSTRACT

Disclosed herein is a SMF (106) that receives a session request message transmitted by a User Equipment, UE (102), the session request message comprising a DNN and S-NSSAI pair; and after receiving the session request message, the SMF transmits towards a PCF (110), a policy create message that includes one or more of: i) the DNN and S-NSSAI pair from the session request message, ii) information indicating that a user plane for a PDU session for the DNN and S-NSSAI pair is redundancy capable, and iii) subscription information for the UE that indicates that the subscriber is allowed to have redundant transmissions. Also disclosed is a method in a PCF (108) that receives a policy control request comprising a UE identifier that identifies a UE (102); and after receiving the policy control request, obtains from a data repository (112) policy information associated with the UE (102), wherein the policy information includes a list of allowed services; and determines whether any of the allowed services require redundant transmissions;

### TECHNICAL FIELD

Disclosed are embodiments related to policy control for redundant transmissions.

### BACKGROUND

3GPP defines a Policy and Charging Control (PCC) architecture that allows handling PCC in the network. This architecture is defined in 3GPP TS 23.503 (5G) or TS 23.203 (EPS). For the sake of simplicity brevity, the description here is based on the 5G architecture, but similar technology exists in EPC as well.

The PCF (Policy Control Function) is a functional element that encompasses policy control decision and flow based charging control functionalities. The PCF provides network control regarding service data flow detection, gating, Quality-of-Service (QoS) and flow based charging (except credit management) towards the Session Management Function (SMF). The PCF receives session and media related information from an Application Function (AF) and informs AF of traffic plane events.

The PCF shall provision PCC Rules to the SMF via the N7 reference point. The PCF shall inform the SMF through the use of PCC rules on the treatment of each service data flow that is under PCC control, in accordance with the PCF policy decision(s).

The PCF provides UE policies, including Access Network Discovery and Selection Policy (ANDSP), UE Route Selection Policy (URSP), Vehicle-to-Everything Policy (V2XP) via the AMF (N15 interface) transparently to the UE.

The SMF and User Plane Function (UPF) encompasses service data flow detection based on the filters definitions included in the PCC rules and policy enforcement.

### A. Redundant Transmission for High Reliability Communication

In order to support ultra-reliable low-latency communication (URLLC) services, a UE may set up two redundant Packet Data Unit (PDU) Sessions over the 5G network, such that the 5G network sets up the user plane paths of the two redundant PDU Sessions to be disjoint. Support of redundant PDU Sessions is defined in TS 23.501 and includes the following:
i) the UE initiates two redundant PDU Session and provides different combination of Data Network name (DNN) and Single-Network Slice Selection Assistance Information (S-NSSAI) for each PDU Session;
ii) The SMF determines whether the PDU Session is to be handled redundantly, which determination is based on the policies provided by PCF for the PDU Session, combination of the S-NSSAI, DNN, user subscription and local policy configuration; the SMF uses these inputs to determine the RSN which differentiates the PDU Sessions that are handled redundantly and indicates redundant user plane requirements for the PDU Sessions in NG-RAN.

It is also specified in TS 23.501 that in order to establish two redundant PDU sessions and associate the duplicated traffic coming from the same application to these PDU sessions, UE route selection policy (URSP) rules can be sent to the UE, and duplicated traffic from the application, associated to the redundant PDU Sessions, is differentiated by two distinct traffic descriptors, each in a distinct URSP rule. These traffic descriptors need to have different DNNs, Internet Protocol (IP) descriptors or non-IP descriptors (e.g. MAC address, virtual local area network (VLAN) ID), so that the two redundant PDU sessions are matched to the Route Selection Descriptors of distinct URSP rules.

### SUMMARY

Certain challenges presently exist. For example, the SMF cannot determine if a PDU session is to be handled redundantly because one of the inputs is the policies provided by the PCF that are not defined, and there is no possibility for the network to check that the UE that is provisioned with URSP rules to request redundant transmission to two different DNNs is actually using these DNNs to request redundancy transmission.

Accordingly, this disclosure provides embodiments in which a) a PCF determines if a PDU session is handled redundantly based on subscription information that indicates if the subscriber can have redundant transmission and PDU session capabilities to support redundant transmission; the PCF provides a redundancy indication to the SMF and the SMF uses the indication from the PCF to set the Redundancy Sequence Number (RSN) value towards RAN and b) the PCF serving the UE stores the indication of redundant URSP rule pairs per DNN and S-NSSAI that is later used at PDU session establishment to determine if the PDU session should be handled redundantly.

In some embodiments, the PCF, either by subscription and/or local policies is aware of the services that require redundant transmission paths. The PCF then determines: i) whether the redundancy is enabled in the UE for traffic of the applications that require redundant sessions with the definition of the corresponding URSP rules; ii) whether redundancy is enabled in the SMF for the traffic of the applications that require redundant sessions with the redundant PDU session indication sent to the SMF; and iii) whether redundancy is enabled in the SMF for the traffic of the applications that require redundant SDF with the redundant PCC rule indication sent to the SMF.

The embodiments disclosed herein are advantageous in that they provide a way to enable the SMF to establish a redundant PDU session based on the UE subscription and service information held in the PCF. That is the embodiments provide a flexible solution where the PCF assists the SMF to determine whether a redundant PDU session is to be handled.

### BRIEF DESCRIPTION OF THE DRAWINGS

The accompanying drawings, which are incorporated herein and form part of the specification, illustrate various embodiments.

FIG. 1 is a message flow diagram illustrating an embodiment.

FIG. 2 is a flowchart illustrating a process according to some embodiments.

FIG. 3 is a flowchart illustrating a process according to some embodiments.

FIG. 4 is a flowchart illustrating a process according to some embodiments.

FIG. 5 illustrates a CN node according to some embodiments.

### DETAILED DESCRIPTION

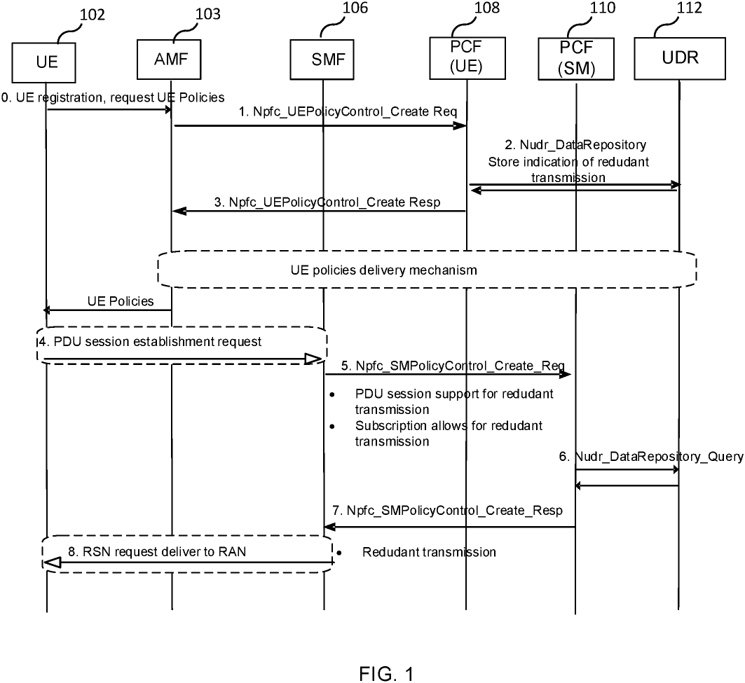

### FIG. 1

FIG. 1 is a message flow diagram illustrating an embodiment.

0. In a first step, a UE 102 transmits a registration request to an AMF 104.

1. The registration request causes the AMF 104 to transmit a policy control request (e.g., a Npcf_UEPolicyControl_Create request) to a PCF 108 and includes in the policy control request a UE identifier that identifies a UE (e.g., a Subscription Permanent Identifier (SUPI) or a permanent equipment identifier (PEI)) and a UE PolicyContainer delivered by the UE 102, if provided by the UE 102 in the Registration Request.

2. After receiving the policy control request, the PCF 108 interacts with a data repository (e.g., a User Data Repository (UDR)) to fetch policy information associated with the UE 102 (e.g., the UE Policy Set stored in the UDR for the UE). This policy information for the UE 102 includes a list of allowed services (each of the allowed services is mapped to a DNN and S-NSSAI pair, and more than one service may be mapped to the same DNN and S-NSSIA pair). The PCF 108 then determines whether any of these allowed services require redundancy transmission. For each one of the services requiring redundancy transmission, the PCF 108 derives two URSP rules (a first URSP rule and a second URSP rule), which will be delivered to the UE and that will be stored in the UDR in association with the service (e.g., stored in association with the DNN and S-NSSAI pair to which the service is mapped).

3. The PCF 108 then responds to the AMF 104 with the a policy control response message (e.g., a Npcf_UEPolicyControl_Create response), which response message includes all of the URSP rule pairs derived by the PCF, which URSP rules allow for redundant transmission, assuming that the PCF determined that the UE should be sent URSP rules for redundant transmission.

3.5 The e2e procedure for UE policies delivery to the UE takes place. That is, the AMF 104 sends to the UE 102 the URSP rule pairs contained in the policy control response message.

4. At some point later, the UE 102 transmits a PDU session request message to establish a PDU session for a particular service (i.e., the particular DNN and S-NSSAI pair to which the service is mapped). Accordingly, the PDU session request message includes the DNN and S-NSSAI pair to which the particular service is mapped. This PDU session request message is received by SMF 106.

5. After the SMF 106 receives the PDU session request message transmitted by the UE 102, the SMF 106 sends to the PCF 110 a policy create message (e.g., a Npcf_SMPolicyControl_Create request message) that includes: i) the DNN and S-NSSAI from the PDU session request message, ii) information indicating that the user plane for a PDU session for this DNN and S-NSSAI pair is redundancy capable, and iii) subscription information (e.g., Unified Data Management (UDM) subscription information) for the UE that the SMF 106 retrieved from a data management system (e.g., a UDM); this subscription information indicates that the subscriber is allowed to have redundant transmissions. The SMF 106 determines that the user plane for the PDU session is redundancy capable based on RAN (e.g., NG-RAN) capabilities, UPF capabilities, and the DNN and S-NSSAI pair included in the PDU session request. Steps 5, 6, and 7 are not performed if either the subscriber is not allowed to have redundant PDU sessions or the PDU session is not redundancy capable.

6. Next, after receiving the policy create message transmitted by SMF 106, the PCF 110 fetches from the UDR information for the UE that indicates whether or not any of the allowed services for the UE that are mapped to the DNN and S-NSSAI pair included in the policy create message require redundancy. If any of these allowed services require redundancy and the PDU session is redundant capable and the UE is allowed to have redundant transmissions, then the PDU session should be set to redundant and the PCF 110 requests the SMF 106 to establish redundant PDU session by sending to the SMF a policy response message that includes a redundancy indication (e.g., a flag).

7. The PCF 110 sends to SMF 108 the policy response message (e.g., a Npcf_SMPolicyControl_Create response message) that includes the redundancy indication (e.g., a flag) indicating that the PDU session shall be handled as redundant.

8. After receiving the policy response message with the redundancy indication, the SMF 106 transmits to the UE 102 via a RAN a PDU Session Establishment response, this response includes an RSN value, and, because the policy response message included the redundancy indication, the SMF 106 sets the RSN value to request redundancy transmission.

The RAN will read the RSN value and because the RSN value is set to request redundant transmission, the RAN will establish a redundant connectivity with the UE with any available mechanism for redundancy.

As the above demonstrates the PCF 108 stores in the UDR the traffic descriptors for which redundant transmission is required. At Npcf_SMPolicyControl_Create, the SMF 106 provides the PDU session capabilities for support redundancy to the PCF 110. Also, at Npcf_SMPolicyControl_Create, the PCF 110 fetches from the UDR the traffic descriptors and route selection descriptors that require redundancy. At Npcf_SMPolicyControl_Create, and based on operator policies, the PCF 110 decides whether or not to establish a PDU session requiring redundant transmission. Also, the SMF 106 sets the RSN value towards RAN based on the PCF 110 indication.

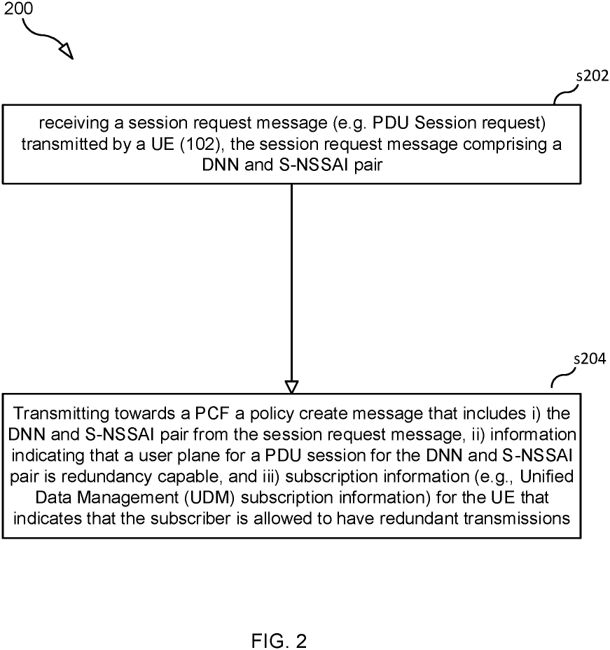

### FIG. 2

FIG. 2 is a flowchart illustrating a process performed by the SMF 110 according to some embodiments.

S202. The SMF 106 receives a session request message (e.g. PDU Session request) transmitted by a UE 102. The session request message comprises a DNN and S-NSSAI pair;

S204. After receiving the session request message, the SMF 106transmits towards a PCF 110, a policy create message (e.g., a Npcf_SMPolicyControl_Create request message) that includes at least one of:
i) the DNN and S-NSSAI pair from the session request message,
ii) information indicating that a user plane for a PDU session for the DNN and S-NSSAI pair is redundancy capable, and
iii) subscription information (e.g., Unified Data Management (UDM) subscription information) for the UE that indicates that the subscriber is allowed to have redundant transmissions.

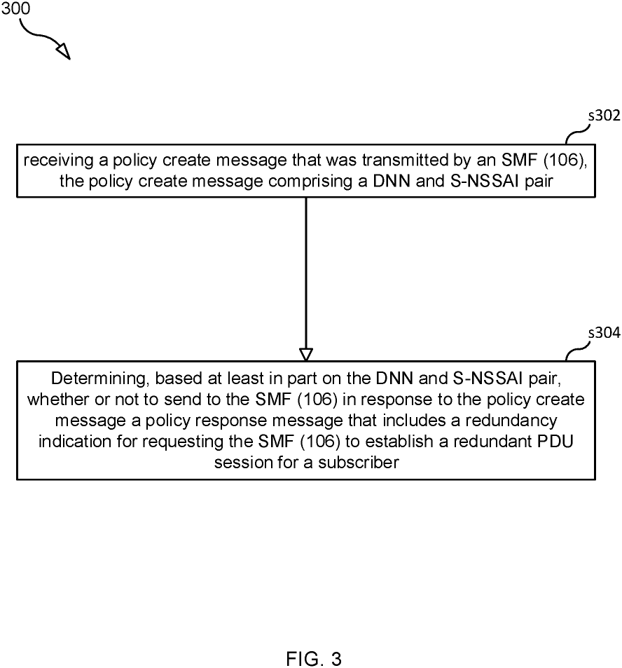

### FIG. 3

FIG. 3 is a flowchart illustrating a process performed by the PCF 110 according to some embodiments.

S302. The PCF 110 receives a policy create message that was transmitted by a SMF 106. The policy create message comprises a DNN and S-NSSAI pair. The policy create message may also contain a subscriber identifier that identifies a subscriber.

S304. The PCF 110 determines, after receiving the policy create message transmitted by the SMF 106, based at least in part on the DNN and S-NSSAI pair, whether or not to send to the SMF 106 in response to the policy create message a policy response message that includes a redundancy indication for requesting the SMF 106 to establish a redundant PDU session for a subscriber, e.g., the subscriber identified by a subscriber identifier included in the policy create message.

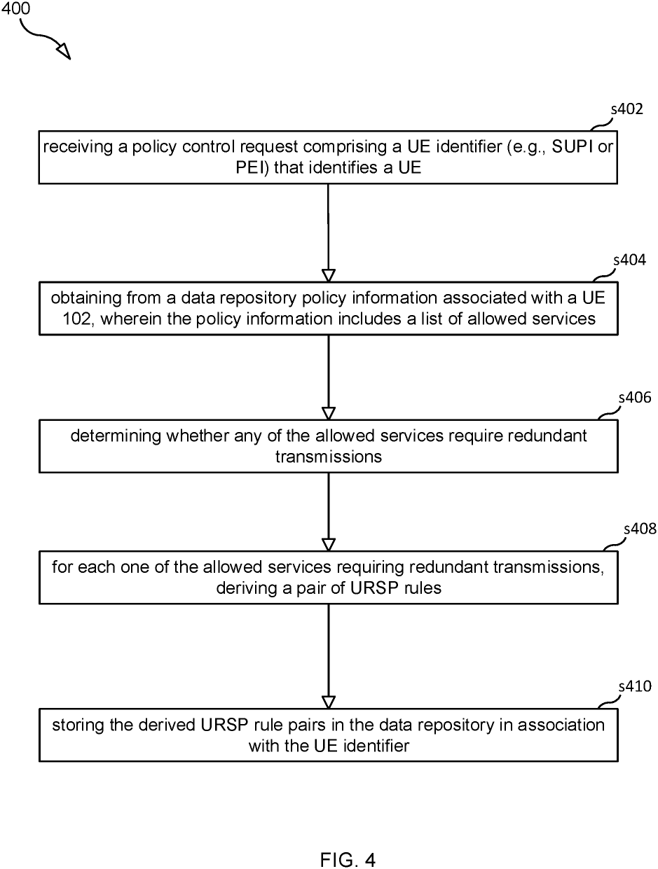

### FIG. 4

FIG. 4 is a flowchart illustrating a process performed by the PCF 108 according to some embodiments.

S402. The PCF 108 receives a policy control request (e.g. a Npfc_UEPolicyControl_Create Request) sent by a AMF 103, which policy control request comprises a UE identifier (e.g. SUPI or PEI) that identifies a UE 102.

S404. The PCF 108 obtains, after receiving the policy control request, from a data repository 112 policy information associated with a UE 102, wherein the policy information includes a list of allowed services.

S406. Then the PCF 108 determines whether any of the allowed services require redundant transmissions;

S408. Then the PCF 108 derives a pair of URSP rules for each one of the allowed services that requires redundant transmissions.

S410. Then the PCF 108 stores the derived URSP rule pairs in the data repository 112 in association with the UE identifier.

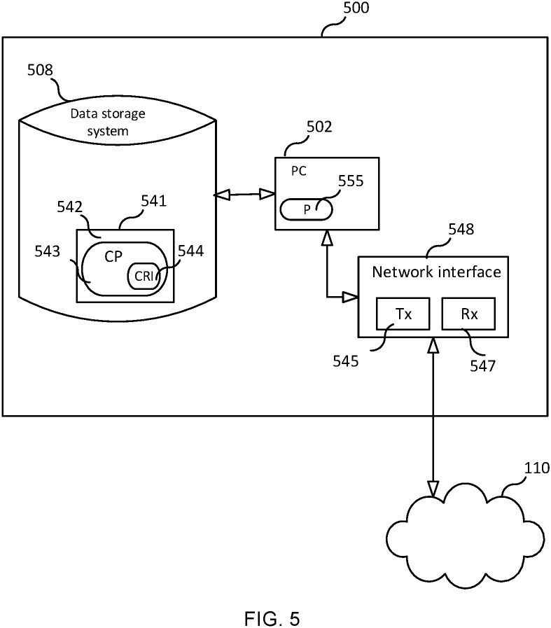

### FIG. 5

FIG. 5 is a block diagram of a core network (CN) node 500, according to some embodiments, for implementing any one of the above described network functions (e.g., AMF, PCF, SMF, NEF, UPF, AF, etc.). As shown in FIG. 5, CN node 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., CN node 500 may be a distributed computing apparatus); at least one network interface 548 comprising a transmitter (Tx) 545 and a receiver (Rx) 547 for enabling CN node 500 to transmit data to and receive data from other nodes connected to a network 110 (e.g., an Internet Protocol (IP) network) to which network interface 548 is connected (directly or indirectly) (e.g., network interface 548 may be wirelessly connected to the network 110, in which case network interface 548 is connected to an antenna arrangement); and a storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes CN node 500 to perform steps described herein (e.g., steps described herein with reference to the flow charts). In other embodiments, CN node 500 may be configured to perform steps described herein without the need for code. That is, for example, PC 502 may consist merely of one or more ASICs. Hence, the features of the embodiments described herein may be implemented in hardware and/or software.

Disclosed herein is, for example, a SMF 106 that receives a session request message transmitted by a User Equipment, UE 102, the session request message comprising a DNN and S-NSSAI pair; and after receiving the session request message, the SMF transmits towards a PCF 110, a policy create message that includes one or more of: i) the DNN and S-NSSAI pair from the session request message, ii) information indicating that a user plane for a PDU session for the DNN and S-NSSAI pair is redundancy capable, and iii) subscription information for the UE that indicates that the subscriber is allowed to have redundant transmissions. Also disclosed is a method in a PCF 108 that receives a policy control request comprising a UE identifier that identifies a UE 102; and after receiving the policy control request, obtains from a data repository 112 policy information associated with the UE 102, wherein the policy information includes a list of allowed services; and determines whether any of the allowed services require redundant transmissions; and for each one of the allowed services requiring redundant transmissions, deriving a pair of URSP rules; and storing the derived URSP rule pairs in the data repository 112 in association with the UE identifier.

### SUMMARY OF VARIOUS EMBODIMENTS

Some embodiments described herein may be summarized in the following manner:
A1. A method (200, see FIG. 2) performed by a session management function, SMF (106), the method comprising:
   the SMF receiving (s202) a session request message (e.g. PDU Session request) transmitted by a UE (102), the session request message comprising a DNN and S-NSSAI pair;
   after receiving the session request message, the SMF transmitting (s204) towards a policy control function, PCF 110, a policy create message (e.g., a Npcf_SMPolicyControl_Create request message) that includes one or more of:
      i) the DNN and S-NSSAI pair from the session request message,
      ii) information indicating that a user plane for a PDU session for the DNN and S-NSSAI pair is redundancy capable, and
      iii) subscription information (e.g., Unified Data Management (UDM) subscription information) for the UE that indicates that the subscriber is allowed to have redundant transmissions.
A2. The method of embodiment A1, wherein the SMF 106 determines that the user plane for the PDU session is redundancy capable based on information indicating RAN capabilities, information indicating UPF capabilities, and the DNN and S-NSSAI pair.
A3. A method (300, see FIG. 3) performed by a PCF (110), the method comprising:
   receiving (s302) a policy create message that was transmitted by an SMF (106), the policy create message comprising a DNN and S-NSSAI pair (the message may also contain a subscriber identifier identifying a subscriber); and
   after receiving the policy create message transmitted by the SMF (106), determining (s304), based at least in part on the DNN and S-NSSAI pair, whether or not to send to the SMF (106) in response to the policy create message a policy response message that includes a redundancy indication for requesting the SMF (106) to establish a redundant PDU session for a subscriber (e.g., the subscriber identified by a subscriber identifier included in the policy create message).
A4. The method of embodiment A3, wherein the step of determining whether or not to send to the SMF (106) a policy response message that includes the redundancy indication comprises:
   the PCF (110) obtaining subscription information for the subscriber and determining whether the obtained subscription information indicates that one or more services that are mapped to the DNN and S-NSSAI pair require redundancy.
A5. The method of embodiment A3 or A4, wherein the policy create message further comprises:
   information indicating that a user plane for a PDU session for the DNN and S-NSSAI pair is redundancy capable, and
   subscription information that indicates that the subscriber is allowed to have redundant transmissions.
A6. A method (400, see FIG. 4) performed by a PCF (108), the method comprising:
   receiving (s402) a policy control request comprising a UE identifier (e.g., SUPI or PEI) that identifies a UE (102);
   after receiving the policy control request, obtaining (s404) from a data repository (112) policy information associated with the UE 102, wherein the policy information includes a list of allowed services;
   determining (s406) whether any of the allowed services require redundant transmissions;
   for each one of the allowed services requiring redundant transmissions, deriving (s408) a pair of URSP rules; and
   storing (s410) the derived URSP rule pairs in the data repository in association with the UE identifier.
A7. The method of embodiment A6, wherein
   each one of said allowed services requiring redundant transmissions is mapped to a DNN and S-NSSAI pair, and
   for each of said allowed services requiring redundant transmissions, the URSP rule pair derived for the allowed service is stored in association with the DNN and S-NSSAI pair to which the allowed service is mapped.
A8. The method of embodiment A6 or A7, further comprising transmitting towards the UE a message comprising the derived URSP rules.
B1. A computer program (543) comprising instructions (544) which when executed by processing circuitry (502) of a CN node (500) causes the CN node (500) to perform the method of any one of embodiments A1-A8.
B2. A carrier containing the computer program of embodiment B1, wherein the carrier is one of an electronic signal, an optical signal, a radio signal, and a computer readable storage medium (542).
C1. A CN node (500), the CN node (500) being adapted to perform the method of any one of embodiments A1-A8.
D1. A CN node (500), the CN node (500) comprising:
   processing circuitry (502); and
   a memory (542), the memory containing instructions (544) executable by the processing circuitry, whereby the CN node is operative to perform the method of any one of the embodiments A1-A8.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a session management function (SMF), the method comprising:
the SMF receiving a session request message transmitted by a user equipment (UE), the session request message comprising a DNN and S-NSSAI pair; and
after receiving the session request message, the SMF transmitting towards a policy control function (PCF) a policy create message that includes:
i) the DNN and S-NSSAI pair from the session request message,
ii) information indicating that a user plane for a PDU session for the DNN and S-NSSAI pair is redundancy capable, and/or
iii) subscription information for the UE that indicates that the subscriber is allowed to have redundant transmissions.

2. The method of claim 1, wherein the SMF determines that the user plane for the PDU session is redundancy capable based on information indicating RAN capabilities, information indicating UPF capabilities, and the DNN and S-NSSAI pair.

3. A method performed by a Policy Control Function (PCF), the method comprising:
receiving a policy create message that was transmitted by an SMF, the policy create message comprising a DNN and S-NSSAI pair; and
after receiving the policy create message transmitted by the SMF, determining, based at least in part on the DNN and S-NSSAI pair, whether or not to send to the SMF in response to the policy create message a policy response message that includes a redundancy indication for requesting the SMF to establish a redundant PDU session for a subscriber.

4. The method of claim 3, wherein the step of determining whether or not to send to the SMF a policy response message that includes the redundancy indication comprises:
the PCF obtaining subscription information for the subscriber and determining whether the obtained subscription information indicates that one or more services that are mapped to the DNN and S-NSSAI pair require redundancy.

5. The method of claim 3, wherein the policy create message further comprises:
information indicating that a user plane for a PDU session for the DNN and S-NSSAI pair is redundancy capable, and
subscription information that indicates that the subscriber is allowed to have redundant transmissions.

6. A method performed by a policy control function (PCF), the method comprising:
receiving a policy control request comprising a user equipment (UE) identifier that identifies a UE;
after receiving the policy control request, obtaining from a data repository policy information associated with the UE, wherein the policy information includes a list of allowed services;
determining whether any of the allowed services require redundant transmissions;
for each one of the allowed services requiring redundant transmissions, deriving a pair of UE Route Selection Policy (URSP) rules; and
storing the derived URSP rule pairs in the data repository in association with the UE identifier.

7. The method of claim 6, wherein
each one of said allowed services requiring redundant transmissions is mapped to a DNN and S-NSSAI pair, and
for each of said allowed services requiring redundant transmissions, the pair of URSP rules pair-derived for the allowed service is stored in association with the DNN and S-NSSAI pair to which the allowed service is mapped.

8. The method of claim 6, further comprising transmitting towards the UE a message comprising the derived URSP rules.

9. A non-transitory computer readable storage medium storing a computer program comprising instructions which when executed by processing circuitry of a network node causes the network node to perform the method of claim 1.

10-11. (canceled)

12. A core network (CN) node, the CN node comprising:
processing circuitry; and
a memory, the memory containing instructions executable by the processing circuitry, wherein the CN node is configured to perform a method comprising:
receiving a session request message transmitted by a user equipment (UE), the session request message comprising a DNN and S-NSSAI pair; and
after receiving the session request message, transmitting towards a policy control function (PCF) a policy create message that includes:
i) the DNN and S-NSSAI pair from the session request message,
ii) information indicating that a user plane for a PDU session for the DNN and S-NSSAI pair is redundancy capable, and/or
iii) subscription information for the UE that indicates that the subscriber is allowed to have redundant transmissions.
